(19) United States
(12) Patent Application Publication
(10) Pub. No.: US 2024/0420136 A1
(43) Pub. Date: Dec. 19, 2024

(54) SYSTEMS AND METHODS FOR BREAKING THE f+ 1 BARRIER: EXECUTING PAYMENT TRANSACTIONS IN PARALLEL WITH LESS THAT f+1 VALIDATIONS

(71) Applicants: Arizona Board of Regents on Behalf of Arizona State University, Tempe, AZ (US); Commissariat à l’énergie atomique et aux énergies alternatives, Paris (FR)

(72) Inventors: Rida Bazzi, Scottsdale, AZ (US); Sara Tucci-Piergiovanni, Paris (FR)

(21) Appl. No.: 18/739,107

(22) Filed: Jun. 10, 2024

Related U.S. Application Data
(60) Provisional application No. 63/507,364, filed on Jun. 9, 2023.

(51) Int. Cl. G06Q 20/40

(52) U.S. Cl. CPC G06Q 20/401

(57) ABSTRACT

Examples of a computer-implemented framework and associated methods for executing payment transactions in parallel with less than f+1 validations are disclosed. The framework includes a novel quorum system called the (k₁,k₂)-quorum systems. In the presence of a non-adaptive adversary, these systems can be used to allow up to k₁ transactions to be validated concurrently and asynchronously but prevent more than k₂ transactions from being validated.

### CROSS REFERENCE TO RELATED APPLICATIONS

This is a non-provisional application that claims benefit to U.S. Provisional Application Ser. No. 63/507,364 filed on Jun. 9, 2023, which is herein incorporated by reference in its entirety.

### FIELD

The present disclosure generally relates to cryptocurrencies and associated digital transactions; and more particularly to a new quorum system that accommodates multiple operations in parallel including protocols thereof to support validation of transactions in an asynchronous system.

### BACKGROUND

Existing cryptocurrencies solve the consensus problem to maintain a shared ledger of all transactions, but it was shown that maintaining a shared ledger is not always strictly needed to support exchanging funds (Gupta, Saurabh. (2016). A non-consensus based decentralized financial transaction processing model with support for efficient auditing. Master's Thesis—Arizona State University). In an asynchronous permissioned system in which at most one third of the servers are subject to Byzantine failures, Byzantine quorums can be used to allow different parties to exchange funds through the system—the asset transfer task. The fact that solving consensus is not needed for asset transfer, when the asset has a single owner, was rediscovered by others who formalized the problem, gave it the name asset transfer task and generalized it to multi-owner objects as well as generalized the approach to work in a permissionless proof-of-stake system. One key insight from Gupta is that (1) Byzantine quorums can prevent double spending because any two quorums must have at least one correct server in their intersection and (2) ordering unrelated transactions is not needed to exchange funds. Consensus-less solutions are important theoretically, but also in practice for their ability to achieve higher throughput and to reduced transaction latency.

Despite the increased efficiency of the consensus-less approach, transaction processing is still fundamentally sequential, If one has a balance of ten coins and wants to pay two coins of the ten coins separately to two different recipients, both transactions would be required to be processed by a common correct server to avoid double spending. This, in turn, necessitates every request to be processed by a full quorum so that any two quorums have at least f+1 servers in common, where f is an upper-bound on the number of faulty servers. The f+1-intersection requirement ensures safety so that no two conflicting payments can be simultaneously validated.

It is with these observations in mind, among others, that various aspects of the present disclosure were conceived and developed.

### BRIEF DESCRIPTION OF THE DRAWINGS

FIGS. 1A and 1B are illustrations showing (k₁,k₂)-quorums intersection requirements where: FIG. 1A shows the intersection of up to k₁ previously selected quorums with Q together with previously corrupted servers in Q does not exceed α|Q|; and FIG. 1B shows the intersection of k₂ (or more) previously selected quorums with Q minus any previously corrupted quorums in the intersection is at least β|Q|.

FIG. 2A is a simplified illustration of a system/framework for implementing the inventive concepts described herein.

FIG. 2B is an example process associated with the inventive concept described herein.

FIG. 3 is a simplified illustration of a computing device that may be implemented with or as part of example systems described herein.

Corresponding reference characters indicate corresponding elements among the view of the drawings. The headings used in the figures do not limit the scope of the claims.

### DETAILED DESCRIPTION

The present disclosure relates to examples of a system and associated methods for executing payment transactions in parallel with less than f+1 validations. In particular, the present concept considers the problem of supporting payment transactions in an asynchronous system in which up to f validators are subject to Byzantine failures under the control of an adaptive adversary. It was shown that this problem can be solved without consensus by using byzantine quorum systems (in some examples requiring at least 2f+1 validations per transaction in asynchronous systems). It is shown that it is possible to validate transactions in parallel with less than f validations per transaction if each transaction spends no more than a small fraction of a balance. The subject inventive solution includes a novel quorum system that is introduced herein and that is called the (k₁,k₂)-quorum systems. In the presence of a non-adaptive adversary, these systems can be used to allow up to k₁ transactions to be validated concurrently and asynchronously but prevent more than k₂ transactions from being validated. If the adversary is adaptive, these systems can be used to allow k₁ transaction to be validated and prevent more than k₂′>k₂ transactions from being validated, the difference k₂′−k₂ being dependent on the quorum system's validation slack, which is defined herein. Using (k₁,k₂)-quorum systems, a payer can execute multiple partial spending transactions to spend a portion of its initial balance with less than full quorum validation (less than f validations per transaction) then reclaim any remaining funds using one fully validated transaction, which is dubbed a settlement transaction.

In cryptocurrencies and associated technologies, such as smart contracts, transactions are executed to make payments either individually from one payer to one or more payees or as a group in which multiple unrelated payments are executed in one large transaction, as is the case in smart contract transactions. In order to avoid double spending from the same funds, such payment transactions need to be validated by a group of validators. In general, validation would require executing a full agreement protocol between validators, which is expensive. In the case of individual payments from one payer to one payee, we saw that Byzantine quorums of validators can be used to validate the transaction without the need for agreement. For payments from funds under the shared control of multiple payers or for multiple individual payments grouped together in one large transaction, executing an agreement protocol becomes necessary in general.

The present inventive concept considers a class of payment transactions in which only a fraction of a balance is spent by each individual payment and proposes a system to enable validating such transactions with less than f+1 validators. The system allows the execution of a minimum number of transactions but places a limit on the number of such transactions that can be executed. The description that follows assumes a single payment transaction between one payer and one payee, but the same system can be used in any setting in which placing an upper limit on the number of transactions that can be executed ensures that double spending is avoided.

### Introduction

The work underlying the present inventive concept started by considering the possibility of relaxing the intersection requirement so that payments from the same single-owner account could be made in parallel while avoiding double spending. In the example above, the two single-coin payments are not conflicting, so we would like to allow them to go through without interfering with each other. At the same time, if there were more than ten such single-coin payments, we would like to prevent some of them from going through. These two requirements seem to be conflicting. The question addressed herein is the following: In an asynchronous system, can we validate non-conflicting asset-transfer transactions in parallel with less than a full quorum of validators while still being able to prevent double spending?

The surprising answer to this question is in the affirmative, albeit with some caveats. The main, and provably unavoidable, caveat is that the total balance amount cannot be fully spent with such non-interfering parallel transactions: the owner can make payments in parallel up to a given threshold. In order to spend the remainder of the balance, the owner needs to use a larger quorum for validation. In particular, the owner can issue a settlement transaction to pay the unspent balance to self. The other main caveat is that the solution is probabilistic. Again, this is probably unavoidable. Finally, it is shown that the described solution works if n>8f but that does not preclude the possibility that the solution works for larger values of f relative to n. An important insight of the solution is captured in the coin example above. If each transaction only spends a fraction of the total balance, then we can execute multiple such partial spendings in parallel, but the total number of such transactions should allow for a buffer between the amount spent and the total balance so that the balance is not exceeded. Even more surprising, it turns out that amounts received through partial spending (without full quorum validation) can also be spent partially without full quorum validation if the original payer is correct. If the original payer is not correct, then payees might not be able to spend the amounts received before settlement, but at no time is double spending possible even if all clients are faulty.

Answering the question in the case of a single owner lead one to reconsider the proven need for solving consensus in order to support transfers from accounts with multiple owners. Intuitively, the need for consensus is to handle double spending from the same account by two different owners. It turns out that partial spending from a multi-owner account is not fundamentally different from the single owner case. The solution herein allows multiple owners to spend parts of the balance independently in parallel up to a threshold. The settlement procedure for multi-owner accounts would require solving consensus, which is to be expected given the impossibility result. The subject protocols only treat the single owner case.

The solution is based on a new quorum system introduced herein that is called a (k₁,k₂)-quorum system. Unlike traditional quorums in which the main requirement is an intersection requirement, (k₁,k₂)-quorum systems have both a non-intersection as well as an intersection requirements. The non-intersection requirement is an upper bound on the size of the overlap between a newly selected quorum and up to k₁−1 previously selected quorums. The intersection requirement is a lower bound on the size of overlap between a newly selected quorum and a set of k₂ or more previously selected quorums (the actual definition is more subtle and should account for previously corrupted validators).

The solution for executing payment transactions would allow a client using a (k₁,k₂)-quorum system to execute with high probability k₁ partial spending transactions, each of which spends at most 1/k₂′ of the client's balance (for a well specified k₂′>k₂), so the total guaranteed spending is k₁/k₂′ of the clients balance. It is possible that the client can succeed in executing more than k₁ partial spending transactions but that is not guaranteed. Finally, with high probability the client cannot successfully execute more than k₂′ partial transactions so the total amount cannot exceed the client's balance. This is achieved even in the presence of corrupt clients that can collude with the servers that validate transactions (the validators).

The combination of intersection and non-intersection requirements of (k₁,k₂)-quorum systems is novel and can potentially be applicable to other settings in which we need to allow a limited amount of concurrent activities. In particular, it is expected that these systems could be applied to some classes of smart contracts in which available funds significantly exceed actual spending which is done in small increments. To summarize the main contributions are the following:
(1) The (k₁,k₂)-quorum systems, a new quorum system that has both intersection and non-intersection requirements. The non-intersection requirements allow multiple operations in parallel and the intersection requirements limit the number of operations that can go through without conflict.
(2) The partial spending problem which formalizes the requirements on partial spending transactions and their corresponding settlements.
(3) The first protocol that allows multiple payment transactions from the same account to be executed in parallel.

### Related Work:

The fundamental bottleneck of blockchains is the underlying consensus protocol used to add blocks to the replicated data structure. To improve blockchain scalability in the context of cryptocurrencies, two approaches emerged: asynchronous on-chain solutions that attempt to create consensus-less blockchain protocols and off-chain solutions, as channels and channels factories, that move the transaction load offline while resorting to a consensus-based blockchain only for trust establishment and dispute resolution.

Asynchronous on-chain solutions rely on the assumption that at most f out of n>3f servers are Byzantine. In such solutions, payments from the same buyer to different sellers cannot be parallelized and they require at least f+1 validations in common (so, at least 2f+1 validation per transaction). As for off-chain solutions, a buyer can set more than one channel to parallelize payments to different sellers, however, all the parties need to agree a priori on the set of participants and cooperate to operate the channel. Cooperation is needed to open the channel (by locking funds as initial balances), update the state of the channel (by signing transactions that attest of the new allocation of balances) and close the channel by sending the last state update to the blockchain and unlock funds. Frauds are avoided by constantly monitoring the state of the blockchain, in the case the other party tries to close the channel with a state update different from the last one. Interestingly, to limit cooperation failures and frauds, one third party system uses a set of n processes, called wardens, to proactively validate state updates associated with increasing timestamps agreed by both parties. To get a validation, the buyer needs to contact a full quorum of t of wardens, with t=2f+1, under the assumption of at most f out of the n=3f+1 wardens are Byzantine and the non-Byzantine wardens are rational. In the subject setting, we allow a buyer to pay potential sellers in parallel, without prior agreement with the sellers and we can support partial spending with validations from less than f validators, all of which can be Byzantine in the case of a corrupt seller.

The closest relative of the (k₁,k₂)-quorum systems that we propose are k-quorum systems. Traditional k-quorum systems relax the intersection requirement of quorum systems. A read-quorum is not required to intersect every write-quorum, but they are required to intersect at least one quorum out of any sequence of k successively accessed write-quorums. Successive write-quorums are not required to have a non-empty intersection, but, unlike (k₁,k₂)-quorum systems, there are no requirement that prevents the intersection of two write quorums from being large in size. In systems with Byzantine failures, quorums have more than f elements, and the intersection of a read quorum with the k previous write quorums should be large enough to ensure that some correct servers are in the intersection. Other quorum systems are probabilistic quorum systems.

### System Model:

We consider an asynchronous message passing system of n servers and an unbounded number of clients. Servers act as validators for client transactions. Up to f servers and any number of clients can be subject to Byzantine failures under the control of an adaptive adversary. The adversary can corrupt any server up to the limit f and any number of clients, but the adversary does not have access to the local memory of participants not under its control. If the adversary corrupts a client or server, then the adversary has full control of the corrupted party including the contents of its memory before it is corrupted. We refer to the parties under the adversary's control as corrupt or faulty and to the parties not under the adversary's control as honest or correct. Corrupt parties can deviate arbitrarily from their protocols. While communication is asynchronous, we make the assumption that messages cannot be selectively delayed to a large enough set of correct servers unknown to the adversary. In other words, if S is a large enough set of correct servers selected by the client's protocol but unknown to the adversary, then any client that sent a request to all servers and is waiting for replies from n−f or n−2f servers, will receive with high probability a reply from an element of S. The justification for this is that the adversary can only guess the identities of a few elements of S and selectively delay their communication but cannot do so for all elements of S. This is consistent with the goals of our solution whose guarantee should hold with high probability and not in the worst case.

We assume that clients and servers use public-key signature and encryption schemes to sign and encrypt messages and that they are identified by their public keys. The public keys of servers are assumed to be known to clients. We assume, but do not explicitly show in the protocols, that messages are signed and signatures are verified. The adversary is computationally bounded and cannot break the encryption or signature schemes. In particular, the adversary cannot read encrypted messages between parties not under its control. Finally, parties have access to a Hash function in the random oracle model or to a verifiable source of randomness.

The adversary can monitor communication between clients and determine which clients are communicating together. We assume that a client can batch messages for multiple transactions together, so that validators for different transactions are contacted together and the adversary cannot tell, just by observing the communication, which of the contacted servers validate which transactions. This point is discussed further when we present the protocols.

### Partial Spending Problem

### Payments and Settlements:

Payment transactions have two clients, the payer and the payee. We refer to them as the buyer and the seller, respectively. We use pkb to denote a buyer b and pks to denote a seller s. Spending is done from funds. A fund F is identified by a unique fund identifier F.id. It has a balance F.bl, where bl is a non-negative amount of money, and one or more owners F.owners associated with it (in the protocols we only consider single owner funds). Funds are certified by validators. Each fund has a certificate F.certificate that consists of a set of validations where each validation has the form ( [symbol] F [symbol] , σ, pkv) such that σ=Signₛᵥₖ( [symbol] F [symbol] ), where [symbol] F [symbol] is an encoding of the fund information (id, balance and owners) and pkv and skv are the public and private keys of the validator v that signed the validation. Even though the description herein considers a single payer and single payee, this is not restrictive. The description can apply to a set of such transactions grouped together in one larger transactions. Also, the use of funds in the description should not be interpreted to mean that the work is restricted to funds that directly represent monetary quantities. A fund can represent any variable whose value can be decremented by transactions.

Depending on the size of F.certificate, we distinguish between fully certified and partially certified funds. A fund is fully certified if the certificate has validations from at least f+1 validators. A fund is partially certified otherwise. Fully certified funds can be initially fully certified, through external means, or are the result of settlement transactions. To keep the presentation simple, we only consider partial spending transactions from fully certified funds in the formal problem definition and solution and we don't consider partial spending from partially certified funds. In the appendix, we explain how spending from partially certified funds can be supported.

For fully certified funds, our protocol allows an honest client (using (k₁,k₂)-quorums), to execute at least k₁ partial spending transactions and at most k₂ such transactions, for some global constants k₁ and k₂ that apply to all partial spending transactions from fully certified funds. In order to avoid double spending by corrupt clients under the control of an adaptive adversary, the amount spent per transaction is F.bl/k₂′, for some k₂′≥k₂. The value of k₂′ is fully defined as a function of k₂, n and f.

A partial spending transaction tx: (F,pkb,pks,PAY) is a transfer of money from fund F with pkb∈F.owners to a recipient pks. Clients and validators execute protocols to validate transactions. If successful, the output of a validation protocol is a certified fund. For partial spending transactions, the output is a partially certified fund. The fund resulting from a transaction (F, pkb, pks, PAY) from fully certified fund F is a partially certified fund F′ such that F′.id is uniquely determined by F.id, pks, pkb and a payment number N_{S} which is uniquely generated by the seller for each payment transaction between pks and pkb to allow for multiple payments from a buyer to the same seller. The balance of F′ is a fraction of the balance of F: F′.bl=F.bl/k₂′, for a global constant k₂′, and F′.owners=pks. The value 1/k₂′ is the partial spending fraction. To keep the presentation simple, we don't support the aggregation of partial spending transactions from separate funds. We note that aggregation can be supported by separate partial spending transactions from separate funds (which can be optimized if the separate funds have the same owners). Also, we note here that the model is different from the UTXO model [14] in which no balance remains in the inputs used for payment. In our model, partial spending transaction leave a balance in the fund from which the payments are made, but the balance is not explicitly maintained. In addition to payment transactions, there are settlement transactions. A settlement transaction (F, SETTLE) specifies a fund F to be settled. The fund being settled can be a fully validated or a partially validated fund, but the fund resulting from the execution of a settlement transaction is fully validated. The identifier of the fund F′ resulting from executing (F, SETTLE) is uniquely determined by the identifier of F. A validated settlement transaction from fund F results in a fund whose owners are the same as those of F and whose balance is equal to the unspent amount in F and is specified in the safety requirements below.

### Problem Definition:

The formal problem definition below only considers requirements for partial spending from initially certified funds (level 1 payments) and settlements associated with those payments. The problem definition does not consider spending from funds resulting from level 1 payments (level 2 payments) or higher level payments that we referred to in the introduction.

The problem requirements ensure that no double spending is possible. In particular, funds resulting from partial spending transactions to honest sellers can always be settled successfully. The same is not true for funds resulting from partial spending transactions to corrupt sellers. In all cases, the total balances of all the funds resulting from settling funds resulting from partial spending transactions from F does not exceed the balance of F. Finally, we need for honest owners the settlement amount is at least the initial balance minus all payments from the fund (requirement 5); it is not guaranteed to be equal because payment to corrupt sellers could be erased by the adversary. These requirements are straightforward to capture.

Before presenting the requirements, we introduce some notation first. For a given fund F, we denote by funds_{F} the set of funds resulting from payment transactions of the form (F, pkb, pks, PAY) and we denote by funds_{F}^{H} the set of such funds for which pks is honest. We denote by settled_{F} the set of fully certified funds resulting from transactions of the form (F_{pay},SETTLE), where F_{pay} ∈funds_{F}; i.e. the set of settlement transactions of funds resulting from spending money from F.

The following holds with high probability (we use with high probability, abbreviated w.h.p., to denote a probability of the form 1−negl(n), where negl(n) is a negligible function in the relevant parameters):
(1) (progress) All partially certified funds with honest owners can be settled successfully: Let F′ be a partially validated fund resulting from transaction (F, pkb, pks, PAY) where F is a fully certified fund and pks is honest. If pks executes transaction (F′, SETTLE), the transaction will terminate resulting a fully certified fund.
(2) (safety) If F″ is a fully certified fund resulting from executing (F′, SETTLE) for partially validated fund F′, then F″.bl=F′.bl.
(3) (safety) There can be at most k₂′ partial spending transactions from a given fund F for a total spending not exceeding F.bl.
(4) (safety) Settlement amounts for payments from F are subtracted from settlement for F: If executing transaction (F, SETTLE) results in a fully certified fund F_{R}: F_{R}.bl≤F.bl−Σ_{F′∈settled}_{_{F}}F′.bl
(5) (safety) If the owner of a fund F is honest, settlement amount is no less than the initial balance of F minus payments made from F: If executing transaction (F, SETTLE) results in a fully certified fund F_{R} and F.owners is honest: F_{R}.bl≥F.bl−Σ_{F′∈funds}_{_{F}}F′.bl
(6) (progress) Non-interference: If a total of k≤k₁ payment transactions are initiated by pkb∈F.owners from fully certified fund F and no additional payment or settlement transactions are initiated by F.owners and pkb is honest, then, every one of the k transactions whose seller (payee) is honest will be validated.
(7) (progress) Successful settlement for fully certified funds: If the owner of fully certified fund F is honest and executes an (F, SETTLE) transaction, the settlement transaction for F will terminate.

Note that for the non-interference requirement, the guarantee of termination for each transaction holds even if the messages for the remaining transactions are arbitrarily delayed by slow sellers for example. In other words, executing one transaction does not interfere with the completion of other transactions if the total number of transactions does not exceed the threshold k₁.

(k₁,k₂)-Byzantine Quorums

As explained in the introduction, (k₁,k₂)-Byzantine quorum systems can be considered under the present inventive solution. We first introduce the properties of our new quorum system, then we propose a construction of a particular quorum system that satisfies these properties. In this section, lemmas and theorems are given without proof. Proofs are given in the Appendix.

(k₁,k₂)-quorums: intersection and non-intersection properties:
Our proposed (k₁,k₂)-quorum systems have both lower bounds and upper bounds on the sizes and composition of quorum intersections. We discuss their requirements informally before giving the formal definitions. In our definitions, we assume, and our protocols ensure, that quorums are selected according to the uniform access strategy in which all quorum sets are equally likely to be selected. We do not distinguish between read-quorums and write-quorums. For the upper and lower bounds on the sizes of intersections, we only consider previously corrupted servers, as opposed to servers that are corrupted in response to quorum selection. Previously corrupted servers are chosen randomly according to a distribution that is induced by the probabilistic access strategy. Even though we only consider previously corrupted servers in our definition of (k₁,k₂)-quorum systems, in our protocols that use these systems, we also consider corruption by an adaptive adversary that might decide on what servers to corrupt based on quorum selection and other information it might have. The k₁,k₂ parameters are such that the following requirements are satisfied:
(Non-intersection requirement): For any selected quorum Q and any [symbol] ≤k₁ other selected quorums, we require that, with high probability, the size of the union of the previously corrupted servers in Q together with the intersection of Q with the [symbol] previously selected quorums does not to exceed a fraction a of the size Q.
(Intersection requirement) For any selected quorum Q and any [symbol] ≥k₂ quorums, we require that, with high probability, the intersection of Q with the union of the [symbol] previously selected quorums minus the previously corrupted servers in Q has a size that exceeds a fraction β of the size of Q. In other words, with high probability, the number of correct servers in Q that have been contacted in the previous [symbol] accesses is more than a fraction β of size of Q.

The non-intersection and intersection requirements are used to ensure that up to k₁ accesses create no conflicts and k₂ or more accesses create a conflict. The idea is to allow a transaction to go through if less than a fraction of the quorum have handled potentially conflicting transactions and to deny it if more than k₁ fraction of the quorum has handled conflicting transactions. The definition takes into consideration previously corrupted servers who can attempt to coordinate their replies to cause the most damage either to prevent a valid transaction from being validated by claiming to have handled conflicting transactions or to allow an invalid transaction to be validated by validating conflicting transactions. The requirements do not say anything about what holds if k₁< [symbol] <k₂, which is not an issue for the protocols using these systems. The reason for using two parameters α and β instead of only α has to do with the adaptive adversary who can corrupt a randomly chosen quorum after it is chosen. By corrupting selected servers, the adversary can flip a decision from denying a request to accepting a request. As we will see below, the difference between β and α determines how costly it is for the adversary to flip a decision and places an upper bound on the number of such flipped decisions that the adaptive adversary can achieve. In what follows we give the formal definition of (k₁,k₂)-quorum systems.

Definitions: A (k₁,k₂, α, β, ϵ, δ)-quorum system is a collection [symbol] of sets such that:

(1) Lower bound: [symbol] [|Q ∩ ( [symbol] ∪∪_{jϵJ1} Qⱼ)| > α|Q|] ≥ 1 − ϵ
(2) Upper bound: [symbol] [|Q ∩ (∪_{jϵJ2} Qⱼ)) − [symbol] | ≤ β|Q|] ≥ 1 − δ

where [symbol] is the set of faulty servers that existed prior to the random choice of Q.

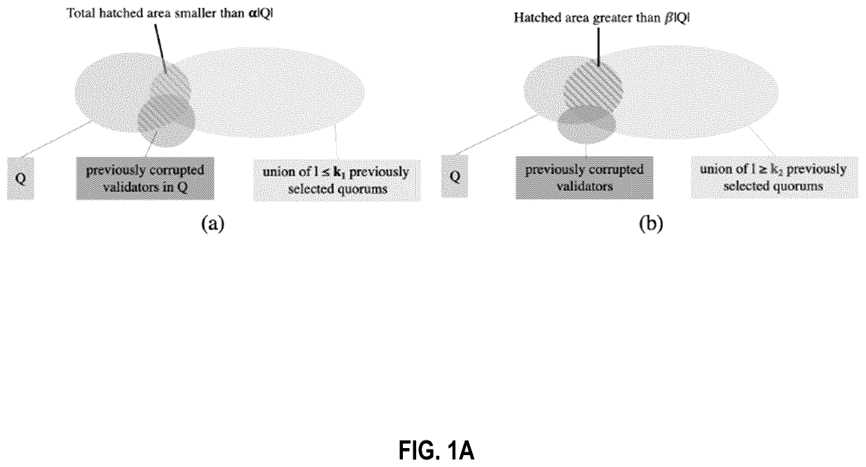

The lower and upper bound requirements in the definition correspond to the non-intersection and intersection requirements stated above and can be best understood by referring to FIGS. 1A and 1B.

The definition contains many parameters. The ϵ and δ parameters are essentially security parameters that need to be small enough (negligible, in the formal security sense) for the given application. The α and β parameters are used for separating the lower and upper bounds. The main parameters from a client point of view are the k₁ and k₂ parameters, assuming E and δ are negligible, hence we refer to these systems as (k₁,k₂)-quorum systems.

In (k₁,k₂)-quorum systems, individual quorums can be of size less than f, which means that even if the randomly chosen quorum does not have any faulty servers, it can be completely corrupted by the adaptive adversary if the adversary knows which servers are in a quorum. In our protocols, this can happen if the seller is corrupt. The definition of the system guarantees that if no more than k₁ accesses are made, less than α fraction of servers in a quorum will deny a request. If more than k₂ access are made, then more than β fraction of the servers (none of them previously corrupted) will deny the request. In order for the adaptive adversary to flip the decision, it will need to corrupt (β−α)|Q| servers. In fact, by definition, the β|Q| servers consisting of previously non-corrupt servers will deny the request with high probability. This number will need to be reduced to no more than α|Q| servers and that would require corrupting (β−α)|Q| servers, so that only α|Q| remains. This is the motivation for defining the validation slack.

Definitions: The validation slack of a (k₁,k₂, α, β, ϵ, δ)-quorum system is equal to (β−α)|Qₘᵢₙ|, where Qₘᵢₙ is the minimum quorum size.

In total, in a payment protocol using a (k₁,k₂, α, β, ϵ, δ) quorum system, it is possible for at most k₂+f/((β−α)|Qₘᵢₙ| accesses to be made: k₂ accesses could go through without the intervention of the adversary but the additional f/((β−α)|Qₘᵢₙ| accesses can only be achieved by adaptively corrupting validators when clients are corrupt.

(k₁,k₂)-Quorums Construction

In this section, we propose a simple construction of a (k₁,k₂)-quorum system to show that they can be constructed. Our construction is not optimal and a more careful choice of the system parameters could yield better performance. Exploring the design space for (k₁,k₂)-quorum systems is contemplated but not described.

Definition: An (m, n) uniform balanced (k₁,k₂)-quorum system is a quorum systems in which each quorum has size m, |U|=n=(k₁,k₂)m and quorums are selected uniformly at random.

Lemma: An (m, n) uniform balanced quorum system is a (k₁,k₂) quorum system with a=⅓ and β=⅔ has ∈=δ=negl(m) and validation slack=m/3, if p_{f}+a₁<⅓ where a₁=k_{1 m/n} and P_{f}=f/n.

Asynchronous (k₁,k₂)-Quorum Systems

The calculations and definition of (k₁,k₂)-quorum systems implicitly assume that all servers in a quorum reply to a request from a client. In order to access a quorum in an asynchronous system, the access should allow for non-responding corrupt servers that cannot be timed out. Assuming that the corrupt servers in a given quorum are randomly chosen, the expected number of corrupt servers in a quorum of size m is at most mp_{f}, where P_{f}=f/n is an upper bound on the probability that a randomly selected server has been previously corrupted. With high probability, the number of corrupt servers in a quorum is less than (1+μ)+mp_{f} for any constant μ, 0>μ>1, and large enough m. In other words, the probability that the number of corrupt servers in a quorum exceeds (1+μ)+mp_{f} is a negligible function of m. It follows that, when contacting a random quorum unknown to the adversary, an honest client can wait for replies from m(1−(1+μ)mp_{f}) servers and be guaranteed w.h.p. to receive that many replies. Of those replies, m(1−2(1+μ)mp_{f}) are guaranteed w.h.p. to be from non-corrupt servers.

These considerations affect our definition and calculations for (k₁,k₂)-quorums in asynchronous systems. The intersection and non-intersection properties should allow for the exclusion of (1+μ)mp_{f} servers, which could be correct. We revise the definition as follows.

Definition: A(k₁,k₂, α, β, ϵ, δ, μ)—asynchronous quorum system is a collection of Q of sets such that ∀Qₛ: |Qₛ|≤(1+), the following holds

(1) Lower bound: Pr_{Q}Qⱼ ← Q;j ∈ J₁; |J₁| ≤ k₁[|(Q − Qₛ) ∩ (Fₚᵣ ∪ U_{jϵJ}_{₁}
Qⱼ)| > α|Q|] ≥ 1−ϵ
(2) Upper bound: Pr_{Q}Qⱼ ← Q;j ∈ J₂; |J₂| ≤ k₂[|(Q − Qₛ) ∩ (U_{jϵJ}_{₂} Qⱼ) −
Fₚᵣ| ≤ β|Q|] ≥ 1 − δ

where [symbol] is the set of faulty servers that existed prior to the random choice of

This definition requires the intersection and non-intersection properties to hold even if we exclude any set Qₛ of size up to (1+μ)mp_{f} servers from the intersection. Again, the definition has too many parameters. We want μ and α and β to be specific constants for which ϵ and δ are small enough. We prove in the appendix the following lemma.

Lemma: An (m,n) uniform balanced (k₁,k₂)-quorum system is a (k₁,k₂, ϵ, δ, a=⅓, δ=⅔, μ>0)-asynchronous quorum system with ϵ=δ=negl(m) and validation slack=m/3, if n>8f and k₁m/n< 1/24.

### Solution Overview

We assume that we have a buyer with a fully certified fund to be spent with partial spending transactions. To understand the difficulties in coming up with a working solution, we start with a solution that does not work. Then, we successively show how the solution should be modified until we get a working solution. As a first attempt, to make a payment, we can require the buyer to get the transaction validated by a (k₁,k₂)-quorum of validators and present the validation to the seller. The idea is that, given the properties of (k₁,k₂)-quorum systems, the buyer should not be able to validate more than k₂ partial spending transactions and thus double spending is avoided. It turns out that buyer validation is fundamentally flawed due to concerns about settlement and quorum choice. We consider that next.

Buyer shouldn't learn the identities of validators: The buyer can always contact the same corrupt quorum for validation which would allow for the validation of more than k₂ transactions. To prevent the buyer from choosing the same quorum, we can involve the seller in the choice of the quorum, a choice that should be randomized using the output of the random oracle (hash function) seeded with a combination of nonces provided by the seller and the buyer. This would ensure that the choice is random and, if the seller is honest, the buyer has little control over the identities of the validators. Choosing the quorum randomly prevents the buyer from validating more than k₂ partial spending transactions, but, if the buyer is corrupt, the adaptive adversary would know the identities of the validators and would be able to corrupt them after they are chosen. While the number of transactions that can be validated would still be bounded even if the adversary can corrupt servers in chosen quorums (discussed below), the adversary can create problems when transactions are settled. In fact, consider a fully certified fund F from which a payment is made to an honest seller resulting in partially validated fund F′. If F is settled before F″ and the validators of F′ are corrupted by the adaptive adversary, they can deny knowledge of F″ and F″ will not be counted against F's balance. This would either result in double spending when F′ is settled or in denying the settlement of F′ in violation of the problem requirements. This scenario is possible because the buyer knows the identities of the validators and the adversary is adaptive. It follows that the solution should avoid giving the buyer knowledge of the identities of the validators. In our solution, the seller, without involvement from the buyer, chooses the quorum of validators. This works because the buyer's and the seller's interests in getting proper validation are at odds. An honest seller has interest in getting as many validators as possible for a given transaction because that would ensure that there is a record of the transaction that they can claim at settlement time. A corrupt buyer has the opposite interest in that it would want to erase any record of a transaction in the hope that the transaction would not count against its balance at settlement time. Of course, the quorum should be randomly chosen and dependent on input from the seller in addition to the transaction identifier. Still this does not solve all the issues. We discuss this next.

Protecting the seller during settlement: In the previous section, we discussed how the adversary should not learn the identities of the validators of an honest seller. During settlement, the seller needs to fully validate the settlement transaction and therefore needs to prove to new validators that were not involved in validating the partially validated fund being settled that the fund is properly validated. For that the seller needs to divulge the identities of the validators that validated its partially validated fund. The seller cannot send the information to all validators because it is possible for one corrupt validator to receive the information before everyone else. At that point, the adversary learns the identities of the validators and corrupt them to erase their record of the transaction then the buyer can settle its own fund before the seller's settlement request is received by non-corrupt validators, thereby repeating the scenario above. The same scenario can occur during the settlement of a buyer's fund F when validators ncommunicate with each other to determine if there are any partial spending transactions from F that need to be subtracted from the balance owed to the buyer. If the adversary delays the validators' communication except for a pre-chosen corrupt validator, the adversary can learn the identities of all validators that validated partial spendings from F and could then corrupt them to erase the record of some of those partial spendings.

To prevent this from happening, divulging the identities of validators can be done using secret sharing. Using secret sharing, the information is divulged in two stages. In a first stage the holder of the information (the dealer) shares the secret information and in the second stage, the secret information is reconstructed. This way, when the adversary learns the information, it is too late to erase it. In our setting, we only require that information provided by honest validators can be recovered. Other methods for divulging information can be considered.

Buyer should limit number of validators: Since a validator does not validate more than one payment from a given fund, the seller should not get validations from many validators because that can affect the ability of the buyer to get other partial spending transactions validated. The solution to this is to have the buyer approve the validators, but that needs to be done without the buyer learning the identities of the validators. This can be achieved by having the buyer blindly sign a limited number of validation approvals such that one approval cannot be used with two different validators. This way, the buyer cannot contact more than a fixed number of validators for a given transaction and the buyer does not learn the identities of the validators.

If the adversary is adaptive, the partial spending amount should account for an adaptive adversary and a corrupt seller: If the seller is corrupt and the adversary is adaptive, then the identities of the validators is known to the adversary, who can then corrupt validators in the selected quorum adaptively. The adversary is limited in the number of validations beyond k₂ by the validation slack which we have discussed earlier. We require that if a (k₁,k₂)-quorum system with validation slack s is used, then the partial spending fraction should not be 1/k₂ but 1/k′₂, where k₂=k₂+f/sᵥ.

Corrupt buyer and seller: If both the buyer and the seller are corrupt, then it is possible to corrupt all the validators in the chosen quorum and erase the record of some payments. This should not create an issue because the amounts that can be erased are only those involving corrupt sellers. Since at settlement time everyone is contacted and a large quorum must validate the settlement, the buyer and the seller cannot simultaneously receive credit for the erased transaction.

### Partial Spending and Settlement Protocols

We start by presenting the protocol for choosing quorums randomly, then we present the partial spending protocol and we finish with the settlement protocol. In what follows we assume that an asynchronous (k₁,k₂)-quorum system construction is known to all participants with the parameters k₁,k₂, α, β, μ, and m available as global constant values.

### Random Quorum Selection

The (k₁,k₂)-quorum systems definition is just a mathematical construction that assumes that a quorum can be chosen randomly, so we need to specify how quorums can be chosen randomly by the seller and how to prevent corrupt sellers from fixing the membership of the chosen quorum.

The protocol (Algorithm 10 shown in the Appendix) allows the seller to choose a quorum of m validators and ensures that if the seller is correct, the quorum of validators is chosen uniformly at random and is not known to the adversary or to the buyer. The arguments to the algorithm are a buyer-provided transaction identifier tx= [symbol] F, pkb, pks [symbol] that ties the chosen quorum to the two parties and the specified fund, and a seller-generated random r-bit string NₛN, where r is a security parameter. The transaction's identifier is concatenated (denoted with ∥) with Nₛ to obtain a seller transaction identifier Tₛ, which is used as a seed for quorum selection. This seed is guaranteed to be unique w.h.p. if the seller is not corrupt. The goal is to select m different servers. The seller uses the seed h concatenated with an index j and feeds it to a function H that that generates a random output. The function H can be a hash function in the random oracle model or a verifiably random function. The seller selects the validator Server(H(h∥j)), where Server is a function that maps the output of H to server identifiers. Since the number of possible validators is n, it is possible that the same validator is chosen twice for different values of j, so the seller tries successive values of j until m distinct validators are chosen. The algorithm returns the identities of the selected validators. This information is all that is needed to verify later that a particular quorum of validators was properly chosen according to the protocol. In fact, the set of chosen validators is a deterministic function of the protocol arguments, but this requires knowledge of Nₛ without which an adversary cannot guess the identities of the validators.

It is important to point out that the randomness of the quorum is ensured by using [symbol] F, pkb, pks [symbol] ∥Nₛ as a seed quorum selection and that a corrupt seller cannot reuse an old seed to double spend because this would result in the same seller transaction identifier.

The protocol (Algorithm 10 shown in the Appendix) allows the seller to choose a quorum of m validators and ensures that if the seller is correct, the quorum of validators is chosen uniformly at random and is not known to the adversary or to the buyer. The arguments to the algorithm are a buyer-provided transaction identifier tx= [symbol] F, pkb, pks [symbol] that ties the chosen quorum to the two parties and the specified fund, and a seller-genera random r-bit string NₛN, where r is a security parameter. The transaction's identifier is concatenated (denoted with ∥) with Nₛ to obtain a seller transaction identifier Tₛ, which is used as a seed for quorum selection. This seed is guaranteed to be unique w.h.p. if the seller is not corrupt. The goal is to select m different servers. The seller uses the seed h concatenated with an index j and feeds it to a function H that that generates a random output. The function H can be a hash function in the random oracle model or a verifiably random function. The seller selects the validator Server(H(h∥j)), where Server is a function that maps the output of H to server identifiers. Since the number of possible validators is n, it is possible that the same validator is chosen twice for different values of j, so the seller tries successive values of j until m distinct validators are chosen. The algorithm returns the identities of the selected validators. This information is all that is needed to verify later that a particular quorum of validators was properly chosen according to the protocol. In fact, the set of chosen validators is a deterministic function of the protocol arguments, but this requires knowledge of Nₛ without which an adversary cannot guess the identities of the validators.

The quorum selection protocol satisfies the following properties, which we prove in the appendix.

Algorithm 1 Partial spending: Buyer's Protocol

| | | |
|---|---|---|
| 1: | procedure BUYERPARTIALSPEND(pks) | |
| 2: | tx := [symbol] F, pkb, pks [symbol] | [symbol] Transaction Id |
| 3: | send (PAY, tx)to pks | [symbol] Send payment message with |
| | | transaction Id |
| 4: | wait | [symbol] Wait until commitments |
| 5: | until (QUORUM,tx,Q_{c} = [cᵢ]) received from pks | Received from seller |
| 6: | if \|Q_{c}\| = m then | [symbol] If quorum has the correct |
| | | size, |
| 7: | send (SIGNED_QUORUM, tx, [Sign_{skb}(tx ∥ hₛ ∥ cᵢ)] ) to | Sign and send response |
| | pks | |
| 8: | else | [symbol] otherwise |
| 9: | return ⊥ | [symbol] abort |

LEMMA 1: If the seller is correct, the quorum of validators is chosen uniformly at random.

LEMMA 2: If the seller is correct, the identities of the correct validators in the chosen quorum are not known to the adversary or to the buyer.

LEMMA 3: For 0<μ<1, if a seller choses K quorums, of size m each, at random, then with probability at most Ke^{-μ}^{²}^{×p}^{_{f}}^{m/(2+μ)}, every chosen quorums has no more than (1+μ)p_{f}m previously corrupt validators.

### Partial Spending Protocols

The partial spending protocols for the buyer and seller are shown in Algorithms 1 and 2 respectively. The validator code relating to partial spending is shown in Algorithm 3. The code closely follows the solution overview above. In the code we assume that the quorum parameters including the validation slack vₛ are fixed and known by all parties and therefore the partial amount to be paid from fund F, which is equal to F.bl/(k₂+f/vₛ), needs not be explicitly shown in the code. These parameters can also be provided as input to these functions, but that is not done here to keep the exposition simple. The presented code assumes that the system is asynchronous. The code also works for synchronous systems. The code can be further optimized for synchronous systems by using smaller quorums.

Buyer's Code. The buyer sends a PAY message specifying the transaction identifier (recall that we only consider partial spending transactions in the protocols). The buyer then waits for a response from the seller which will be a vector of commitments [c_{i]} [c] to the identities of a quorum of validators (explained below in the overview of the seller's code). The buyer checks that the quorum size is m and sends a reply that includes for each validator a signature of tx∥cᵢ to link the commitment to the transaction. The buyer does not need to check that the chosen quorum is valid. That is done when the seller settles the payment.

Seller's Code. The seller's SELLERPARTIALSPENDING( ) function is executed in response to a PAY message from the buyer and takes the tx of the PAY message as argument. The seller starts by calling SELECTQUORUM( ) using the buyer's transaction identifier and a randomly generated nonce Nₛ. The call returns a quorum of validators Qₜₓ represented as a vector of validators [vᵢ]. The seller generates m r-bit nonces that it uses in generating a vector of commitments [cᵢ]=[H(vᵢ∥Nᵢ)] to the validators identities, which it sends to the buyer, and waits to receive from the buyer the signed commitments. Then the seller sends to each validator a validation request that includes the transaction identifier tx, the signature σᵢ (which should be equal to Sign_{skb}(tx∥cᵢ)), and the nonce Nᵢ used in generating the commitment. It then waits to receives replies from m−(1+y)p_{f}m validators and checks if (1−a)m validators validated the transaction. If so, the transaction is validated and the replies from validators that validated the transaction constitute a certificate of validation for the transaction. In the code, we do not explicitly represent the resulting fund, but we note that the transaction, and therefore the fund that it creates, is specified by the transaction identifier tx= [symbol] F, pkb, pks [symbol] and hs, the seller's commitment to the nonce Nₛ.

Algorithm 2 Partial spending: Seller's Protocol

| | |
|---|---|
| 1: | procedure SELLERPARTIALSPENDING(tx) |
| 2: | [vᵢ] = Qₜₓ ← SELECTQUORUM(tx, Nₛ ← {0,1}^{r}) |
| 3: | [Nᵢ] ← [({0,1}^{r})^{m}] [symbol] Nᵢ is seller's blinding nonce for i'th |
| | validator |
| 4: | [cᵢ] ← H(vᵢ ∥ Nᵢ) [symbol] cᵢ is commitment to i'th validator's |
| | identify |
| 5: | hₛ = H(Nₛ) |
| 6: | send (QUORUM, tx, hₛ, [cᵢ]) to pkb |
| 7: | wait until (SIGNED_QUORUM, tx[σᵢ]) received from |
| | pkb |
| 8: | for all v ∈ Qₜₓ do |
| 9: | send [symbol] tx, hₛσᵢNᵢ [symbol] to v |
| 10: | replies = witnesses = Ø |
| 11: | repeat |
| 12: | if received resp from v ∈ Qₜₓ ∧ v ∉ replies [symbol] validators while keeping track |
| | then of |
| 13: | replies = replies ∪ {v} |
| 14: | if resp = [symbol] valid, tx, hₛ, σ = Signₛₖᵥ (tx ∥ hₛ) [symbol] then |
| 15: | witnesses = witnesses ∪ (resp, v) |
| 16: | until \|replies\| ≥ m − (1 + μ)p_{f}m |
| 17: | if \|witnesses\| ≥ (1 − a) × m then |
| 18: | return [symbol] tx, Nₛ, witnesses [symbol] [symbol] return certificate for partial spending |
| | transaction |
| 19: | else |
| 20: | return ⊥ |

Algorithm 3 Validator v Payment Validation

| | |
|---|---|
| 1: | if received [symbol] tx, hₛ, σ, N [symbol] from pks ∧tx.F ∉ settle ∧ |
| | (tx.pkb ∈ tx.F.owners)∧(tx.pks = pks)∧(tx.F ∉ validate_fund) ∧ |
| | VERIFYSIG(tx.pkb,tx ∥ hₛ ∥ H(v ∥ N)),σ) then |
| 2: | validated_fund = validated_fund ∪ F |
| 3: | validated_transactions = validated_transactions ∪ [symbol] tx, hₛ, σ, N [symbol] |
| 4: | send [symbol] valid, tx, hₛ, Signₛₖᵥ(tx ∥ hₛ) [symbol] to pks |
| 5: | else |
| 6: | send [symbol] invalid, tx [symbol] to pks |

Validator's Code. The validator checks for the validity of the request and sends the result of the validation to the seller. A request is valid if: the fund from which the payment is made has not been settled; the seller specified by the transaction is the one making the request; the buyer specified in the transaction is the buyer specified in the fund of the transaction; the fund specified by the transaction has not been previously validated by the validator; the signature U in the request is a valid signature for tx∥c by the buyer tx.pkb specified in the request; and, c is a valid commitment to the validator's identity. If the request is valid, the validator adds the fund to the set of validated funds and the transaction to the list of validated transactions. The list of validated funds is needed to ensure that a validator validates only one partial payment from a given fund. It is used during settlement of buyer's fund F to ensure that all partial spending from F will be accounted for. That is why σ, c and N which are needed to validate a transaction are stored along with tx.

### Settlement Protocols

As we explained in the solution overview, during settlement there is a need to prevent the adversary from learning the identities of the validators prematurely and corrupting them. The settlement algorithms use a PROPOGATE( ) protocol that allows a party to propagate information to all but 2f correct servers without the adversary having the ability to suppress the information being propagated. We outline one implementation of the PROPOGATE( ) protocol first (the details and code are in the appendix), then we present the settlement protocols for the seller, buyer and validators.

Propagating Information. As we discussed in the protocol overview, the adversary can corrupt a validator if it learns that the validator validated a particular transaction and the adversary wants to suppress that information. The identities of validators that are involved in validating a particular transaction are kept secret by the validators themselves (if honest) or the seller until settlement time. The PROPOGATE( ) protocol allows a party (seller or validator) to send a message to all validators so that the adversary would either have to corrupt the party to learn the message or, if the adversary learns the message without corrupting the party, then all but 2f honest are also guaranteed to learn the message. The PROPOGATE( ) protocol can be implemented using secret sharing and reconstruction, but other approaches can be considered depending on the system's assumptions. To distinguish between messages propagated by different calls to PROPOGATE( ) by clients, a unique Nₚᵣₒₚ nonce is generated for the call and provided as a second argument to PROPOGATE( ). When a message from client c is finally propagated to a server, the server will have message[c,Nₚᵣₒₚ] equal to the propagated message. The details are given in the Appendix.

Seller's Settlement and Corresponding Validation. The settlement algorithm for the seller is straightforward. The seller propagates a settlement request to validators. The fund is fully specified by tx= [symbol] F, pks, pkb [symbol] and Nₛ of the partial spending transactions that created the fund. The certificate of the fund consists of the set of payment_witnesses that validated the partial spending transaction. The information tx, Nₛ, payment_witnesses enables a validator of the settlement transaction to recalculate the quorum used in validating the transaction and to verify that the witnesses are provided by members of that quorum. The validator checks that the quorum and validations provided by the seller are correct and that the validation for the transaction are received from a large enough subset of validators. In addition, the validator checks that either it has no record of SETTLE transaction for F (F∉settle) or the transaction being settled, represented as (tx, hₛ=H(Nₛ)) was added to transactions[F] which is the set of transactions calculated when the buyer settles F. This check is needed to avoid double spending. As shown in the proofs, if the buyer settles F, every payment to an honest seller will be added to transactions[F] which ensures that this condition will be satisfied for honest sellers. If all the information checks out, the validator sends a validation for the settlement. The seller waits until it receives n−f validations, which is guaranteed to happen if the seller is correct. These n−f validations guarantee that only one fund can result from settling a partially certified fund. Finally, note that the settlement of the seller's partially certified fund can go through even the validators that validated the original spending transaction are corrupted.

Buyer's Settlement and Corresponding Validation. To settle the buyer's fund F, we need to make sure that all partial spending from the buyer's fund are deducted from the settled balance. The buyer's starts by sending a settlement request to all validators. Every validator that receives the buyer's request propagates information about any payments from F to sellers that it is aware of (there can only be at most one such payment per validator). A validator will either provides proof that it witnessed a payment or states that it did not witness any payment. The proof of a witnessed payment (tx, σ, Nₕ) where σ=Sign_{pkb}(H(tx∥Nₕ)) is the blind signature and Nₕ is the blinding factor. Validators wait until n−f different messages about payments from F are propagated. Every validator then counts the number of different payment transactions from F that it heard about, calculates the resulting balance after subtracting the amounts for those payments and send the seller a signed balance for the settlement fund (see problem definition). The buyer waits until it receives n−2f signatures for the same balance which will form the set of witnesses for the settlement fund resulting from F. The code is given in the Appendix.

Algorithm 4 Seller Find Settlement

| | |
|---|---|
| 1: | procedure SELLERSETTLE(tx = F, pkb, pks), Nₛ, payment_witness |
| 2: | Nₛₑₜₜₗₑ ← {0,1}^{r} |
| 3: | PROPOGATE (tx, Nₛ, psyment_{witness}) SETTLE [symbol] , Nₛₑₜₜₗₑ) |
| 4: | repeat |
| 5: | if received (valid, σ, Nₛₑₜₜₗₑ) from v then |
| 6: | Id₁ = H(tx∥Nₛ∥PAY); Id₂ = H(Id₁∥SETTLE) |
| 7: | F′.id = Id₂; F′.bl = F.bl / k₂′; F′.owners = {pks} |
| 8: | if σ = Signᵥ( [symbol] F′.id, F′.bl, F′.owners [symbol] then |
| 9: | settle_witnesses = settle_witnesses ∪ {(v, σ)} |
| 10: | until \|settle_witnesses\| ≥ n − f |
| 11: | F′.certificate = settle_witnesses |
| 12: | return ( [symbol] F′ [symbol] ) |

Algorithm 5 Code of Validator v for Seller Fund Settlement

| | |
|---|---|
| 1: | if message┌pks, Nₛₑₜₜₗₑ┐ = [symbol] tx, Nₛ, payment_witness, SETTLE [symbol] ∧ |
| | Q = SELECTQUORUM (tx, Nₛ) ∧ |
| | ((tx, H(Nₛ)) ∈ transactions [F] v F ∉ settle) ∧ |
| | VALIDATEDTRANSACTION (tx, payment_witnesses) ∧ |
| | Q′ = {q: (resp, q) ∈ payment_witnesses} ⊆ Q ∧ \|Q′\| ≥ m − mμp_{f} then |
| 2: | transactions[F] = transactions[F] ∪ {(tx, H(Nₛ))} |
| 3: | Id₁ = H(tx∥Nₛ∥PAY) |
| 4: | Id₂ = H(Id₁∥SETTLE) |
| 5: | F′.id = Id₂; F′.bl = F.bl/k′₂;F′.owners = {pks} |
| 6: | send (valid,Signᵥ ( [symbol] F′.id, F′.bl, F′.owner [symbol] ,Nₛₑₜₜₗₑ ) to pks |

### CONCLUSION

We introduced (k₁,k₂)-quorum systems and shown how to use them to execute payment transactions with less than f validations per transaction. By carefully considering intersection and non-intersection properties, we are able to allow up to k₁ non-interfering payments in parallel and prevent double spending by limiting the number of such concurrent transactions. It might seem that the construction succeeds because when the seller is honest, the quorum is randomly selected and has, with high probability, a small fraction of corrupt validators. We observe that in the case of corrupt sellers, the whole quorum could be corrupted, and our definition of k₂′ was done explicitly to handle that possibility. The constructions we proposed work for large values of n. It is not clear how to modify the constructions to work for smaller values of n and larger values of f relative to n, or how to reduce the difference between k₁ and k₂. This is a subject for future work.

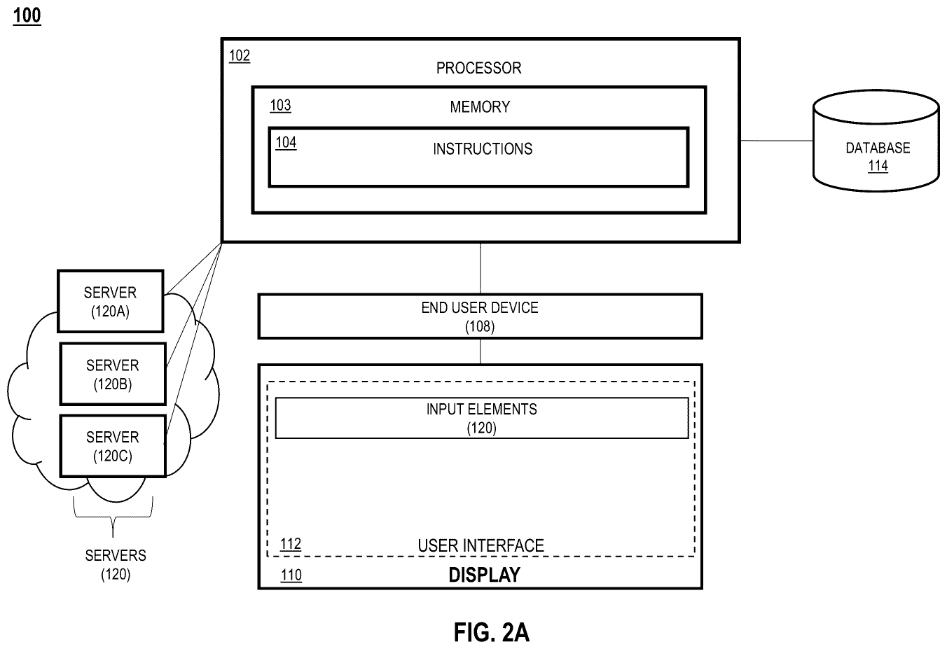

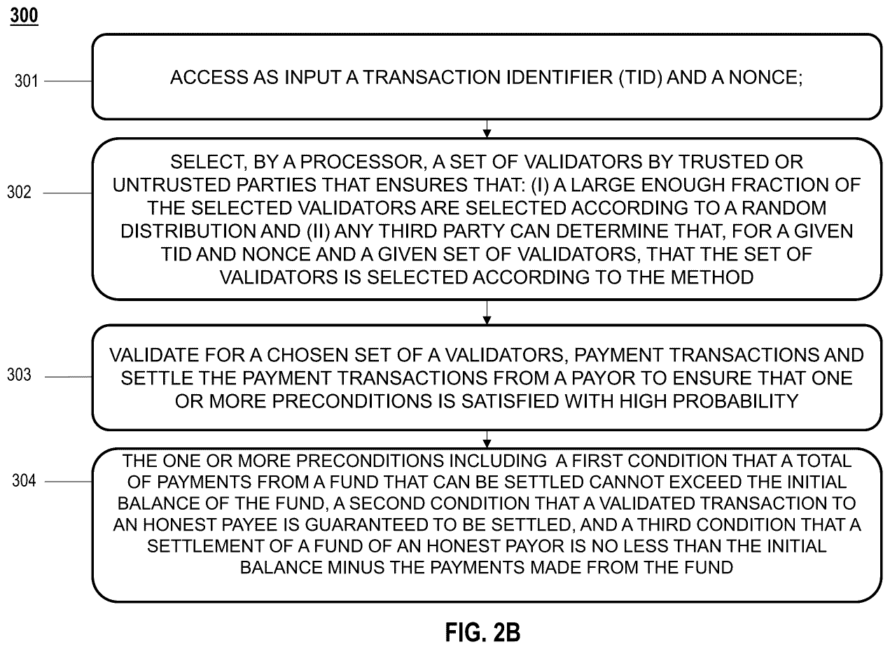

Referring to FIG. 2A, embodiments of a system described herein may take the form of a computer-implemented system, designated system 100, configured for executing payment transactions in parallel with less than f+1 validations. In general, as indicated, the system 100 includes at least one processor 102 or processing element that is configured for executing functions/operations described herein, e.g., the processor 102 can execute instructions 104 stored in a memory 103 including any form of machine-readable medium. In general, the processor 102, via instructions, accesses input data and is configured to execute payment transactions in parallel with less than f+1 validations, configured for asynchronous message passing for validating non-conflicting asset-transfer transactions in parallel with less than a full quorum of validators while preventing double spending, among other functions described herein.

The instructions 104 may be implemented as code and/or machine-executable instructions executable by the processor 102 that may represent one or more of a procedure, a function, a subprogram, a program, a routine, a subroutine, a module, an object, a software package, a class, or any combination of instructions, data structures, or program statements, and the like. In other words, one or more of the features for processing described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103 and/or the memory of computing device 1200), and the processor 102 performs the tasks defined by the code. In some embodiments, the processor 102 is a processing element of a cloud such that the instructions 104 may be implemented via a cloud-based web application.

In some examples, the processor access input data from an end user device 108 in operable communication with a display 110. An end-user, via a user interface 112 rendered along the display 110, can provide input elements 114 to the processor 102 for executing functionality herein. In addition, examples of the system 100 include one or more servers 120 as described herein.

Referring to FIG. 2B, an exemplary process 300 executable by, e.g., the processor 102 of FIG. 2A, includes the illustrated steps in blocks 301-304.

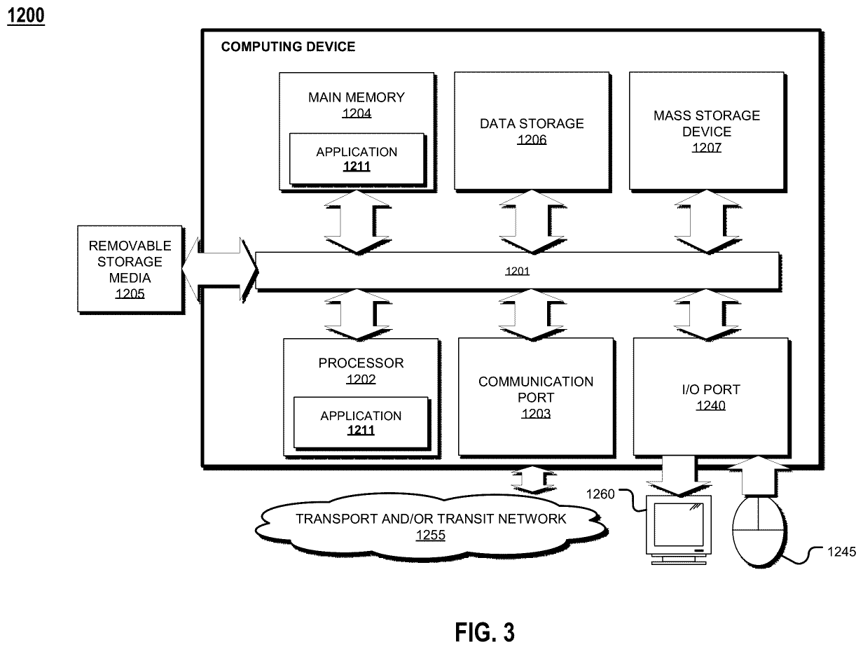

Referring to FIG. 3, a computing device 1200 is illustrated which may be configured, via the instructions 104 and/or other computer-executable instructions, to execute functionality described herein. More particularly, in some embodiments, aspects of the system and/or methods described herein may be translated to software or machine-level code, which may be installed to and/or executed by the computing device 1200 such that the computing device 1200 is configured to functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

### APPENDIX

This appendix contains the following:
(1) Partial spending from partially validated funds (Section I): This section includes a description of how partially validated funds can be spent without full validation. It turns out that this is possible if the buyer is correct, but a corrupt buyer can prevent some such payments, but it will be detected.
(2) Impossibility Proofs (Section II): shows that no solution to the partial spending problem that tolerates an adaptive adversary can be deterministic or allow the spending of the whole balance.
(3) Propagating Information (Section III): This section includes the protocols for propagating information and its correctness proof.
(4) Partial Spending and Settlement (Section IV): This section provides code for the buyer settlement protocol and the proofs that our solution for the payment and settlement satisfy the problem requirements.
(5) (k₁,k₂)-Quorum Systems Properties (Section V): This section provides the proofs for the lemmas relating to (k₁,k₂)-quorum systems that are listed in the main text.
(6) Quorum Selection Protocol Proofs (Section VI): This section contains proofs of the lemmas relating to the quorum selection protocol.
   I Partial Spending from Partially Validated Funds

If a buyer pays a seller with a partial spending transaction, how can the seller turn around and spend some of the received amount without first settling the fund? It turns out, maybe not surprisingly, that in our asynchronous system model with an adaptive adversary, this does not seem to be achievable without some restrictions. One issue is the inability of the seller to prove to a potential buyer that it has a properly validated level-1 payment because that would require divulging the identities of the validators, which is problematic as we described. Also, it is not clear that a zero-knowledge proof of validity is possible. A seller who is the recipient of level-1 payment has only the validation from the buyer (the signatures of the hashes) that it can share as part of a level-2 payment. This would at least prevent a seller who has not received a level-1 payment from attempting to make a level-2 payment, but this is a weak guarantee because both the buyer and the seller can be corrupt.

We outline the main idea for supporting level-i payments, but do not present any protocols. The idea for supporting level-i payments, i>1, is the following. We start with a buyer who has an fully certified fund. The buyer can make up to k₂′ level-1 partial spending transactions. If we want to spend from the resulting k₂′ funds (level-2 payments), we can do k₂′ partial spendings from each one of them resulting in k₂′ level-2 partial spending transactions. So, in general, our approach will allow a total of k₂′ⁱ level-i spending transactions, i≥1.

Of course all of this should be done so that double spending is not possible. For level-1 payments, the total spending can be as high as k₂′*F.bl/k₂′=F, and potentially there might be no funds left for level-2 payments! One way to deal with this is to reduce the partial spending fraction from 1/k₂′ to ½k₂′. This way, the total of level-1 payments is k₂′ *F.bl/2k₂′=F.bl/2. The total for level-2 payments is k₂′²*F.bl/4k₂′²=F.bl/4. So the total spending at all levels is F.bl/2+F.bl/4=F.bl/8= . . . ≤F.bl. So, essentially, multi-level spending from partially certified funds can achieved by increasing the amount that cannot be spent from a given balance. Also, it would require that the fund level be part of the fund description, which could be maintained as a chain of spending transactions starting from level-1 up to the level of the fund.

One limitation of this approach is that it does not guarantee for every recipient of a level-1 payment the ability to make k₂′ level-2 payments. Instead, the guarantee is on the total number of level-2 payments. With this solution, a corrupt buyer, can issue many level-1 payments that are not properly validated to sellers under the control of the adversary. These sellers can then make level-2 payments that consume the total quota of level-2 payments. So, if the buyer is corrupt, a seller can be denied the opportunity to make level-2 payments, but the buyer's corruption will be detected. The situation can be worse as we go up the levels. Nonetheless, the fact that level-2 and higher payments can be made at all is surprising.

### II Impossibility Proofs

We show that a deterministic solution cannot satisfy all the problem's requirements (above) and that no solution that uses less than full quorums can spend the whole amount and avoid double spending.

LEMMA II.1. If all spending transactions are partially certified (certified by quorums of size less than f+1), then a deterministic solution to the spending problem defined above cannot guarantee progress with w.h.p. for correct buyers and sellers.

PROOF. In a deterministic solution, the identities of the validators for a given transaction is solely determined by the buyer and seller identifiers pkb and pks, the history of transactions at the buyer and seller and the initial states of the buyers and sellers. Consider an execution in which all payments are made by one buyer and assume that the buyer pays the seller with a partial spending transaction. The identity of the validators that will be used by the seller can be calculated by the buyer because it has all the information needed to do that. If the buyer is corrupt, the adversary can learn the identities of the validators for the transaction and corrupts all of them because they number less than f+1. The seller can then be prevented from successfully settling the fund resulting from the transaction.

LEMMA II.2. If all quorums used in validation have size less than f+1, then it is not possible to prevent double spending and allow the spending of the whole balance of a fund.

PROOF. We consider an execution in which a buyer spends the whole amount in a fund F by executing k partial spending transactions, T₁, T₂, . . . , Tₖ, for some k, to honest sellers who validate and accept the payments. No validators are corrupted during the executions of these k partial spending transactions. After these partial spending transactions are validated, the adversary corrupts the buyer who issues a partial spending transaction T to a corrupt seller. To validate the transaction, less than f+1 validators are contacted to validate the transaction. In a general solution, some of the validators for a transaction are contacted directly by the seller and buyer and some of them could be contacted indirectly by other validators. Since the adversary controls the buyer and seller, it knows the identities of the validators that are directly contacted and can corrupt them because there are at most f validators involved in validating the transaction. In turn, and for the same reason, this allows the adversary to learn the identities and corrupt any validators that are used to validate the transaction whether they are directly or indirectly contacted by the seller and buyer. Since all the validators for transaction T can be corrupted by the adversary, the transaction can be successfully validated and successfully settled. Since the transactions T₁, T₂, . . . , Tᵢ are to honest sellers, according to the problem requirements, the sellers for these transactions should be able to successfully settle the funds resulting from them, resulting in a total spending that exceeds the original balance F, a double spending.

Algorithm 6 Propagating Information: Client c's code

| | |
|---|---|
| 1: | procedure PROPAGATECLIENT (message, Nₚᵣₒₚ) |
| 2: | [sᵢ]= SECRETSHARE (message, n, f) |
| 3: | for i := 1 → n do |
| 4: | send (SHARE, Nₚᵣₒₚ,sᵢ,Sign_{c}(sᵢ∥vᵢ∥Nₚᵣₒₚ) to vᵢ |
| 5: | acks [Nₚᵣₒₚ = Ø] |
| 6: | repeat |
| 7: | if received (SHARE_ACK, Nₚᵣₒₚ) from v then |
| 8: | acks [Nₚᵣₒₚ] = acks[Nₚᵣₒₚ] ∪ {v} |
| 9: | until \|acks[Nₚᵣₒₚ]\| > n − f |
| 10: | send (RECONSTRUCT, Nₚᵣₒₚ) to validators |
| 11: | reconstructed [Nₚᵣₒₚ] = Ø |
| 12: | repeat |
| 13: | if received (RECONSTRUCTED, message, Nₚᵣₒₚ) from v then |
| 14: | reconstructed [Nₚᵣₒₚ] = reconstructed[Nₚᵣₒₚ] ∪ {v} |
| 15: | until \|reconstructed [Nₚᵣₒₚ]\| ≥ n − f |

### III Propagating Information: Protocols and Properties

As we discussed in the protocol overview, the adversary can corrupt a validator if it learns that the validator validated a particular transaction. The identities of validators that are involved in validation are kept secret by the validators themselves (if honest) or the seller until settlement time, at which time they need to be divulged. The PROPAGATE(protocol allows a party (seller or validator) to send secret information to all validators so that the adversary would either have to corrupt the party to learn the information or, if the adversary learns the information without corrupting the party, then all but f honest are also guaranteed to learn the information. The PROPAGATE(protocol is implemented using secret sharing and reconstruction. The code is given in Algorithms 6 and 7.

Propagating information is relatively simple in our setting and is easier than the asynchronous verifiable secret sharing problem (a solution to which can also be used, but would be an overkill). The client protocol takes as input two arguments: the message being propagated and a unique nonce Nₚᵣₒₚ to distinguish between different calls to the propagate protocol. The client c who propagates the information creates shares of the information that needs to be propagated so that any f+1 out of n shares can be used to reconstruct the message. Depending on the settlement protocol, c is either a seller or a validator. Each share sᵢ is addressed to a particular validator vᵢvᵢ. In addition to the share sᵢ, vᵢ receives from the client a signature σ=Sign_{c}(sᵢ∥vᵢ∥Nₚᵣₒₚ) that vᵢ can later use to prove that sᵢ is a properly received share. After the shares are distributed and n−f>f+1 validators acknowledge receiving the shares, the client sends a RECONSTRUCT message so that the validators can reconstruct the message from the shares. Validators broadcast their shares and collect shares that they authenticate until f+1 authenticated shares are collected. At that point, the message is reconstructed using the collected shares. It is important to note here that all the shares used in the reconstruction are validated to be form the client (line 9 of validator code), so if the client is honest, the f+1 shares will all be valid even if they are received from corrupt validators. If the client is not honest, we don't care about the value that is reconstructed. A validator stops participating in the propagation protocol for a particular Nₚᵣₒₚ when n−f different validators announce that they have reconstructed the messages. Of those validators, n=2f must be honest.

Algorithm 7 Propagating Information: validator v's code. The client c in the
code can be either a seller invoking the client side of information propagation
to settle a fund resulting from partial payment or a validator invoking
propagation information to handle a buyer's settlement transaction

```
procedure PROPAGATESERVER(Nₚᵣₒₚ)
  repeat
  upon receipt of (Share, Nₚᵣₒₚ, s, σ = Signₚₖₛ(s∥v∥Nₚᵣₒₚ) from c:
    send (SHARE_ACK, Nₚᵣₒₚ) to c
    share[c, Nₚᵣₒₚ] = s, σ
  upon receipt of (RECONSTRUCT, Nₚᵣₒₚ) from c:
    send (FORWARD, c, share [c, Nₚᵣₒₚ], Nₚᵣₒₚ ) to validators
    shares [c, Nₚᵣₒₚ] = Ø, Forwarded [c, Nₚᵣₒₚ] = Ø
  upon receipt of (FORWARD, c, s, σ Nₚᵣₒₚ) from v:
    if σ = Sign_{c}(s∥v∥Nₚᵣₒₚ) ∧ v ∉ Forwarded [c, Nₚᵣₒₚ] then
      shares [c, Nₚᵣₒₚ] = shares (c, Nₚᵣₒₚ) ∪ {(s, σ)}
      Forwarded [c, Nₚᵣₒₚ] = forwarded (c, Nₚᵣₒₚ) ∪ {v}
      if |shares [c, Nₚᵣₒₚ]| ≥ f + 1 then
        message [c, Nₚᵣₒₚ] = ReconstructSecret(shares [c, Nₚᵣₒₚ])
        send (RECONSTRUCTED, message [c, Nₚᵣₒₚ], Nₚᵣₒₚ ) to c and
validators
until (n − f) RECONSTRUCT messages received
```

The algorithms guarantees that if the client calling PROPAGATE(message) is honest, all but 2f honest validators will receive message. If the client propagating the shares is not honest, there are no guarantees as to what is reconstructed and the reconstruction might even fail, but that does not affect the algorithms that use the PROPAGATE(function.

LEMMA III.1. If an honest client calls PROPAGATE(m), all but 2f honest validators will be guaranteed to receive m.

PROOF. (sketch) If the client is honest, when a validator receives a RECONSTRUCT message, n−f validators must have already received the SHARE message. Of these validators n−2f≥f+1 validators are honest and will each send FORWARD message containing its share to every other honest validator who will be able to reconstruct the message. Validators stop their execution when they receive n−f RECONSTRUCT messages from other validators. Of these n−2f are from honest validators.

LEMMA III.2. Let N be a random value that is generated by a client c such that no value that is directly or indirectly dependent on N is sent to any validator with the exception of H(N). If the adversary learns N w.h.p., then w.h.p. the adversary must have corrupted the client c.

PROOF. (sketch) The proof is by induction on the number of messages sent by c. If c sends no messages, it should be clear that the adversary cannot learn N without corrupting c. Assume that the lemma holds for the first i messages sent by c and consider the i+1 message sent by c. The i+1 message either contains no value dependent on N or contains H(N) and other values that are not dependent on N. In the first case, the adversary clearly doesn't learn anything about N. In the second case, given the adversary's bounded computational power, it cannot learn the value of N except with negligible probability. It follows that the chain must be a 0-length chain and the adversary learns N by corrupting c.

Algorithm 8 Buyer Fund Settlement

| | |
|---|---|
| 1: | procedure BUYERSETTLE(F) |
| 2: | send (SETTLE, F) to validators |
| 3: | repeat |
| 4: | if received resp from qi then |
| 5: | replies = replies ∪ resp |
| 6: | until ∃F′: \|resp : resp ∈ replies ∧ resp = F′\| = n − |
| | 2f |
| 7: | Return F′ |

LEMMA III.3. Let N be a random value that is generated by a client c such that no value that is directly or indirectly dependent on N is sent to any validator with the exception of H(N) or by executing PROPAGATE(m) for a message m that depends on N. If the adversary learns N w.h.p., then w.h.p. the adversary must have corrupted the client c or all but 2f honest validators are guaranteed to learn m.

PROOF. (sketch) Since each share generated by the secret sharing of the PROPAGATE(m) is independent of N, by an argument similar to that in the previous lemma, the adversary cannot learn N w.h.p. if it does not learn f+1 shares. If the adversary learns N, then it must have corrupted a validator that received f+1 valid shares. One of these shares must be from an honest validator that received a RECONSTRUCT message. It follows that n−f validators must have received a reconstruct message and all of these validators send FORWARD messages to all other validators who will be able to reconstruct m. Validators participate in the protocol until n−f validators announce that they reconstructed the message at which point n−2f honest validators must have reconstructed the message.

It might seem a little strange that even though every honest validator sends messages to every other honest validator, we only guarantee that n−2f validators will receive the message if the adversary doesn't corrupt the client. The reason is that even though honest validators might be guaranteed to receive messages sent by other honest validators eventually, we need to make a statement about what holds when the execution of PROPAGATE(m) ends.

### IV Partial Spending and Settlement Proofs

The protocol for buyer fund settlement is shown in Algorithms 8 and 9. The rest of this section presents the correctness proof of the solution for partial spending and settlement protocols.

We show that the protocol satisfies the problem requirements.

LEMMA IV.1 (TRANSACTIONS TO HONEST SELLERS ARE ACCOUNTED FOR). Let Tₛ=(tx,Nₛ) be a partial spending transactions for which the seller is honest. If the buyer executes (SETTLE,F), then n=2f honest validators will have (tx,hₛ=H(Nₛ))∈transactions[F].

PROOF. (sketch) If the seller already executed a settlement transaction for the fund resulting from Tₛ, then it should have received validations from n−f validators each of which adds (tx,hₛ=H(Nₛ)) to transactions[F]. So, we assume that the seller did not execute a settlement transaction for the fund resulting from Tₛ and did not divulge Nₛ. It follows that the identities of the validators of Tₛ are not known to the adversary which means, by the model assumptions, that some of the honest validators of Tₛ will succeed in propagating their information to n−2f honest validators that add (tx, hₛ) to transactions[F].

LEMMA IV.2. All partially certified funds with honest owners can be settled successfully.

Algorithm 9 Code of Validator v for Buyer Fund Settlement

| | |
|---|---|
| 1: | procedure ValidatorBuyerSettle (F, pkb) |
| 2: | if received (SETTLE, F) from pkb ∧ pkb ∈ F.owners then |
| 3: | Nₚᵣₒₚ ← {0,1}ⁿ [symbol] different validators choose |
| | different Nₚᵣₒₚ values |
| 4: | value [F, Nₚᵣₒₚ] =⊥ [symbol] F will have multiple entries, one for |
| | each such value |
| | [symbol] If v is witness to payment from F, |
| | propagate payment info |
| 5: | if ∃ (tx, hₛ, σ, N) ∈ validated_transactions ∧ tx.F = F ∧ and pkb ∈ tx.owners then |
| 6: | PROPOGATE ( [symbol] F,SETTLE [symbol] [symbol] ,v,(tx,hₛ,σ,N),Nₚᵣₒₚ) |
| 7: | else [symbol] otherwise propagate that v is not |
| | witness to any payment from F |
| 8: | PROPOGATE ( [symbol] F ,SETTLE [symbol] [symbol] ,v,Signᵥ(F∥none),Nₚᵣₒₚ) [symbol] Update known |
| | transactions [F] based |
| | on propagated |
| | information |
| 9: | if message [F, Nₚᵣₒₚ] = [symbol] F, SETTLE [symbol] [symbol] , v, (tx, hₛ, σ, N), Nₚᵣₒₚ) then |
| 10: | transactions[F] = transactions [F] ∪ {(tx, hₛ)} [symbol] Forward any witness |
| | or non-witness |
| | information received |
| 11: | if message [F, Nₚᵣₒₚ] = ( [symbol] F, SETTLE [symbol] ,v′,*) then |
| 12: | send (F, SETTLE, value [F, Nₚᵣₒₚ]) to all validators |
| 13: | if received ( [symbol] F, SETTLE [symbol] , v′,*) ∧ v′ ∉ settle_validators[F] then |
| 14: | settle_validators[F] = settle_validators [F] ∪ v′ |
| 15: | if received (F, SETTLE, v′, (tx, σ, N)) ∧ v′ ∉ settle_validators[F] ∧ |
| | VALIDPAYMMENT (F, (tx, hₛ, σ, N)) then |
| 16: | payments [F] = payments[F] ∪ (tx, hₛ, σ, N) |
| 17: | if \|settle_validators[F]\| = n − f then |
| 18: | for all (tx, hₛ, σ, N) ∈ payments [F]: VALIDPAYMENT (tx, hₛ, σ, N) do |
| 19: | transactions[F] = transactions[F] ∪ {(tx, hₛ)} |
| 20: | settle = settle ∪ {F} |
| 21: | if \|transactions[F]\| > k₁ then [symbol] if many transactions were |
| | issued from F |
| 22: | abort [symbol] abort |
| | [symbol] Add F to funds with |
| | SETTLE transactions |
| 23: | new_balance = F.bl − \|transactions[F]\| × 1/k′₂ |
| 24: | F′.tx = H (f.tx); F′.bl = new_balance; F′.owners = F.owners |
| 25: | send (F′, Signᵥ(F′)) to F′.owners |

PROOF. (sketch) Consider a partially certified fund FₛFₛ resulting from a partial spending transaction tx from a fund F. If the owner (seller) of Fₛ is honest, then when the payment was made, the seller selected a quorum according to the quorum selection protocol and then got the payment validated by a sufficient number of honest validators from the selected quorum. The identities of these validators are not known to the adversary before the owner settles the fund. Also, each of these honest validator received the validation request from the seller before receiving a settlement request for F because one of the conditions for validating a payment request is for the validator not to have F is the set of funds for which there is a SETTLE transaction (F.tx∈settle). Every honest validator that receives the settlement request for Fₛ will either have F∈settle or F∉settle. If F∉settle, by the previous lemma, the validator must have added Fₛ to transactions[F]. The validation of the settlement of Fₛ will go through in both cases because the other conditions for validating a seller's settlement transaction will hold because the honest seller provides a correctly selected quorum and a large enough set of witnesses that validates the partial spending transactions that created Fₛ.

LEMMA IV.3. Settlement for a partially certified funds equals payment amount: If F″ is a fully certified fund resulting from executing (F′,SETTLE) for partially validated fund F′, then F″.bl=F′.bl.

PROOF. (sketch) This follows immediately from the code. When a fund F″ of a partial spending transaction is settled, the balance of the resulting fund F″ is equal to F.bl/k′₂ which is also the spending amount (which we do not explicitly represent in the protocols).

LEMMA IV.4. Settlement amounts for payments from F are subtracted from settlement for F: If executing transaction (F, SETTLE) results in a fully certified fund F_{R}:

$${F}_{R} . b l \leq F . b l - {\sum }_{F ' ϵ {settled}_{F}} {F}^{′} . bl$$

PROOF. (sketch) Consider F′∉settled_{F} that results from settling a fund Fₛ identified by transaction (tx, Nₛ) when Fₛ is settled, resulting in F′, either F is not yet settled and (tx, H (Nₛ)) gets added to transactions[F] by the validators of the settlement transaction or (tx, H (Nₛ)) is already in transactions [F]. In either case, when LEMMA IV.5 (NO MORE THAN k_{2+/v}_{ₛ} PARTIAL SPENDING TRANSACTIONS). With high probability, no more than k_{2+f/v}_{ₛ} partial spending transaction can be validated, where vₛ is the validation slack.

PROOF. With high probability, k₂ is an upper bound on the number of partial spendings that can be validated without any failures. If the adversary can only randomly chose the validators to corrupt, which is the case when the seller is honest, then k₂ will also be the number of partial spendings that are possible. So, we assume that k₂ partial spending transactions are executed with no validator corruption. Any additional transactions would have quorums of validators that intersect the previously selected quorums in βm validators and the adversary would need to corrupt (β−α)m for each additional partial spending transactions so that the number of validators that validate the transaction is raised to αm. A total of f/(β−α)m additional spending transactions. The total number of partial spending transactions possible is therefore k₂+f/(β−α)m=k₂+f/vₛ.

LEMMA IV.6. If the owner of a fund F is honest, settlement amount is no less than the initial balance of F minus payments made from F: If executing transaction (F, SETTLE) results in a fully certified fund F_{R} and F.owners is honest:

$${F}_{R} . bl \geq F . bl - {\sum }_{{F}^{′} ϵ {funds}_{F}} {F}^{′} . bl$$

PROOF. (sketch) This follows directly from how the settlement amount is calculated in which only transactions originating from the owner of F are deducted from the resulting balance.

LEMMA IV.7 (NON-INTERFERENCE). If a total of k≤k₁ payment transactions are initiated by pkb c F.owners from fully certified fund F and no additional payment or settlement transactions are initiated by F.owners and pkb is honest, then, every one of the k transactions whose seller (payee) is honest will be validated.

PROOF. (sketch) We consider one of these transactions with an honest seller. The seller will select a quorum of validators according to the protocol and gets validations from the buyer. Then the seller will contact the validators to get the transaction validated. By the properties of (k₁,k₂)-quorum systems, the seller will get replies from m−(1+μ)p_{f}m validators, (1−α)×m of which have not previously validated another transaction from F and the transaction will be validated.

LEMMA IV.8. Successful settlement for fully certified funds: If the owner of fully certified fund F is honest and executes an (F.SETTLE) transaction, the settlement transaction for F will terminate.

PROOF. lemma Since the owner is honest, at most k₁ partial spending transactions from F can be executed. When the (F. SETTLE) transaction is executed, the validators will only have no more than k₁ transactions in transaction[F] because every transaction in transaction[F] must be checked for validity with VALIDPAYMENT(tx, hₛ σ, N) which checks that sigma is a valid signature by the buyer for tx∥hₛ∥N. Since the only potentially blocking condition in the validator's buyer settlement code is when there are more than k₁ transactions in transaction[F], every honest validator that handles the settlement will validate (F. SETTLE) and eventually the buyer will get n−2f identical replies from validators. PROOF. lemma

V (k₁,k₂)-Quorums Properties

LEMMA 5.4. An (m,n) uniform balanced quorum system is a (k₁,k₂)-quorum system with α=⅓ and β=⅔ has ∈=δ=negl(m) and validation slack=m/3, if p_{f}+α₁<⅓,where α₁<⅓=k₁m/n and p_{f}=f/n.

PROOF. We need to show that:

(1) Lower bound: Pr_{Q,Q}_{ⱼ} ← Q;j ∈ J₁:|J₁| ≤ k₁[|Q ∩ ( [symbol] ∪ U_{jϵKJ}_{₁}Qⱼ)| >
m / 3] ≥ 1 − negl(m)
(2) Upper bound: Pr_{Q,Q}_{ⱼ} ← Q;j ∈ J₂:|J₂| ≥ k₂ [|Q ∩ (U_{jϵJ}_{₂}Qⱼ)) − [symbol] | ≤
2m / 3] ≥ 1 − negl(m)

For the lower bound, consider the intersection of a quorum Q with the union of up to k₁ previously selected quorums. Since k₁m/m=α₁, α₁n is an upper bound on the size of the union of the k₁ previously selected quorums because each of them is of size m. The expected size of the intersection of Q with these k₁ previously selected quorums is at most α₁Q=α₁m because the probability that a given randomly chosen server in Q is in the union is at most α₁n/n=α₁. Similarly, the probability that a server in Q is previously corrupted is at most p_{f} and the expected number of servers in Q that are previously corrupted is at most p_{f}|Q|=p_{f}m. So, the expected size of the intersection of Q with the union of the previously corrupted servers together with the union of k₁ previously selected quorums is at most (α₁+p_{f})m. Since α₁+p_{f}<⅓, (α₁+p_{f})m<m/3. Let r=(⅓ (α₁+p_{f}))−1. This value of r is positive and independent of m. For this value of r, we have (1+r)×(α₁+p_{f})m=m/3. So, the probability that the size of the intersection exceeds by a factor 1+r the expected size of the intersection is the same as the probability that the size of the intersection exceeds m/3.

By Chernoff's upper tail bounds [13], the probability that the size of the intersection exceeds by a factor of 1+r, r>0, the upper bound (a₁+p_{f})m on the expected size is:

$${Pr}_{Q ← Q} [ \vert Q ⋂ ( ⋃ {⋃}_{j ϵ {J}_{1}} {Q}_{j} ) \vert \geq ( 1 + r ) \times ( {α}_{1} + {p}_{f} ) m = m / 3 ] \leq {e}^{- {r}^{2} \times ( {α}_{1} + {p}_{f} ) m / 3}$$

which is a negligible function of m. Now, it remains to show that the upper bound requirement holds:

$${Pr}_{Q , {Q}_{j} ← Q ; j ∈ J ; \vert J \vert \geq {k}_{2}} [ \vert ( Q∩ ( {⋃}_{j ϵ J} {Q}_{j} ) - \vert < 2 m / 3 ] \geq 1 - n e g l ( m )$$

The expected number of servers in a quorum Q that are in the union of k₂ previously selected quorums is k₂m/n)|Q|=(1−α₁)m. The expected number of servers in Q that are previously corrupted is less than p_{f}m. So, the expected number of non-corrupted servers in Q that are in one of the last k₂ chosen quorums is at least (1−α₁)m−p_{f}m=(1−(α₁+p_{f}))m>2m/3 because a₁+p_{f}<⅓ as we have noted above. Again, if we define r=1((1−(α₁+p_{f}))/(⅔), we have 0<r<1, and (1−r)×(1−(a₁+p_{f}))m=2m/3. Using Chernoff's lower tail bound, we have

$${Pr}_{Q , {Q}_{j} ← Q ; j ∈ {J}_{2} ; \vert {J}_{2} \vert \geq {k}_{2}} [ \vert ( Q∩ ( {⋃}_{j ϵ J} {Q}_{j} ) ) - \vert \leq ( 1 - r ) \times ( 1 - {α}_{1} + {p}_{f} ) ) m = 2 m / 3 ]$$

$$\leq {e}^{- {r}^{2} ( 1 - ( {α}_{1} + {p}_{f} ) ) m / 2}$$

which is a negligible function of m. It is important to note that r does not depend on m but on the value of α₁+p_{f} which is a constant for a given p_{f} and k₁ and k₂. So, the function above decrease exponentially with m for fixed α₁ and p_{f} satisfying α₁+p_{f}<⅓. Also, for a fixed k₁ and α₁, m grows linearly with n: m=α₁n/k₁. In other words, the probabilities are negligible functions of n for fixed k₁, α₁ and p_{f}.

Even though the proof shows that the probability of not satisfying the (k₁,k₂)-quorum requirements is negligible, values of α₁ and p₁ for which the sum α₁+p₁ is very close to ⅓ result in probability bounds that are not useful in practice. For the parameter choices we made, the validation slack of the system is m/3. Different values for α₁ and p₁ could result in lower validation slack but better overall performance. Determining the optimal combination of parameters is subject of future work.

LEMMA 5.6. An (m, n) uniform balanced quorum system is a (k₁,k₂)-quorum system is a k₁,k₂, ϵ, δ, α=⅓, β=⅔, μ-asynchronous quorum system with ϵ=δ=negl(m) and validation slack=m/3, if n>8f and k₁ m/n< 1/24.

PROOF. The proof is almost identical to that of Lemma 5.4. Recall that for asynchronous (k₁,k₂)-quorum systems, the properties intersection and non-intersection properties should hold even if we exclude from a quorum Q a set Qₛ of size at most (1+μ)p_{f}m. For the non-intersection property, not including some replies can only make the intersection smaller, so the proof that with negligible probability, the intersection size is less than m/3 carries over to this setting. For the upper bound, the only difference is that we are excluding an additional (1+μ)p_{f}n servers in addition to the already excluded p_{f}n servers. The expected size of non-corrupt servers in Q that are also in one of the previous k₂ chosen quorums is at least (1−α₁−p_{f})m−(1+μ)p_{f}m=(1−α₁−(2+μ)p_{f})m. We show that the probability that the size is short by a factor (1−r) of the expected size is negligible, where. r=1−((1−α₁+p_{f}+1+μ)p_{f})⅔. Similarly to what we did in Lemma 5.4 for the synchronous case, we have 0<r<1 and using Chernoff's lower tail bound, we have for any Qₛ such that |Qₛ|≤mp_{f}(1+μ):

$${Pr}_{Q , {Q}_{j} ← Q ; j ∈ {J}_{2} ; \vert {J}_{2} \vert \geq {k}_{2}} [ \vert ( ( Q - {Q}_{s} ) ∩ ( ( {⋃}_{j ϵ J} {Q}_{j} ) - ) \vert ] < 2 m / 3 ] \qquad ( 1 )$$

$$= {Pr}_{Q , {Q}_{j} ← Q ; j ∈ {J}_{2} ; \vert {J}_{2} \vert \geq {k}_{2}} [ \vert ( Q ∩ ( ( {⋃}_{j ϵ J} {Q}_{j} ) - - {Q}_{s} ) \vert ] < \qquad ( 2 )$$

$$\leq {e}^{- {r}^{2} / 2 \times ( 1 - ( {α}_{1} + {p}_{f} ) ) m} \qquad ( 3 )$$

### VI. Random Quorum Selection

The algorithm for random quorum selection is shown in Algorithm 10. The following lemmas establish the relevant properties of the algorithm.

LEMMA 7.1. If the seller is correct, the quorum of validators is chosen uniformly at random.

Algorithm 10 Random selection of a quorum of size m: Seller's's Code (pks)

| 1: | function SELECTQUORTUM( [symbol] F, pkb, pks [symbol] , Nₛ) | |
|---|---|---|
| 2: | Tₛ = [symbol] F, pkb, pks [symbol] ∥Nₛ | [symbol] Seller's transaction identifier |
| 3: | h = H(Tₛ) | |
| 4: | Q = { };j = 1; | |
| 5: | while \|Q\| < m do | |
| 6: | if Server(H(h∥j)) ∉ Q then | [symbol] If server not previously |
| | | selected, |
| 7: | Q = Q ∪ {Server(H(h\|j))} | [symbol] add server to quorum |
| 8: | j = 1 + 1 | |
| 9: | return Q | |

PROOF. If the seller is correct, the validators are chosen using the hash function on different input values, seeded with a high entropy ∥Nₛ, that w.h.p. have not been previously selected, until m different validators are chosen. Given that the hash function is modeled as a random function, each of these validators will be chosen randomly.

LEMMA 7.2. If the seller is correct, the identities of the correct validators in the chosen quorum are not known to the adversary or to the buyer.

PROOF. Under the assumption that the adversary cannot intercept the messages of the seller relating to one transaction (Section 3), the adversary can only learn about the transaction from corrupt servers that are selected as part of the quorum or by guessing the seed. Given that the seed has high entropy, it cannot be guessed other than with negligible probability. The rest of the proof follows directly from the fact that the validators are randomly chosen. All validators that are not under the control of the adversary are equally likely to be chosen in a particular quorum.

LEMMA VI.1. The probability that a randomly selected quorum of size m contains (1+μ)p_{f}m previously corrupt validators, 0<μ<1 is at most e^{-μ}^{²}^{×p}^{ₘ}^{/(2+μ)}.

PROOF. Let p_{f}′ be the fraction of validators that have been previously corrupted. p_{f}′<p_{f}. Let Qₘ be the set of subsets of validators of size m. The probability that a randomly chosen validator is corrupt is at most p_{f}′. The expected number of validators that are corrupt in a quorum of size m is at most p_{f}′m. By Chernoff's bounds, we have

$${Pr}_{Q ← {Q}_{m}} [ \vert Q ∩ \vert \geq ( 1 + μ ) {p}_{f}^{′} m ] \leq {e}^{- {μ}^{2} \times {p}_{f}^{′} m / ( 2 + μ )} \leq {e}^{- {μ}^{2} \times {p}_{f} m / ( 2 + μ )} .$$

The following Lemma follows directly from Lemma VI.1.

LEMMA 7.3. For 0<μ<1, if a seller choses K quorums, of size m each, at random, then with probability at most Ke^{-μ}^{²}^{×p}^{_{f}}^{m/(2+μ)}, every chosen quorums has no more than (1+μ)p_{f}m previously corrupt validators.

It is believed that the present disclosure and many of its attendant advantages should be understood by the foregoing description, and it should be apparent that various changes may be made in the form, construction, and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for validating a digital transaction, comprising:
accessing as input a transaction identifier (TID) and a nonce; and
selecting, by a processor, a set of validators by trusted or untrusted parties that ensures that: (i) a large enough fraction of the selected validators are selected according to a random distribution and (ii) any third party can determine that, for a given TID and nonce and a given set of validators, that the set of validators is selected according to the method.

2. The method of claim 1, wherein the processor selects the set of validators using a cryptographically secure hash function in the random oracle model.

3. The method of claim 1, wherein the processor selects the set of validators using a shared source of randomness which can be generated in a distributed manner or other appropriate manner.

4. A method to select a quorum defining a set of validators for payment transactions that ensures that for a given shared transaction identifier (TID) and for two parameters k1 and k2,k1<k2: (1) At least k1 transactions with identifier TID can be validated concurrently and (2) no more than a total of k2 transactions with identifier TID can be validated.

5. The method of claim 4, wherein the quorum comprises a randomly chosen fraction of validators out of the set of validators.

6. The method of claim 4, wherein the set of validators is divided into groups V1, V2, . . . , Vi of validators according to some predetermined criteria (location, capacity, reliability, or other appropriate performance measures) and a quorum comprises randomly chosen fractions validators from each group including different fractions from each group.

7. The method of claim 4, wherein the size of the chosen set of validators depends on the synchrony assumption (synchronous or asynchronous message passing), the failure assumptions (upper bound f on number of faulty validators) and/or the power of the adversary (adaptive or non-adaptive). In all cases, the selection method guarantees that the two properties (1) and (2) are satisfied.

8. The method of claim 4, further comprising, for a chosen set of a validators, validating payment transactions and settling the payment transactions from a payor to ensure that one or more preconditions is satisfied with high probability.

9. The method of claim 8, wherein the one or more preconditions includes a condition that a total of payments from a fund that can be settled cannot exceed the initial balance of the fund, a second condition that a validated transaction to an honest payee is guaranteed to be settled, and a third condition that a settlement of a fund of an honest payor is no less than the initial balance minus the payments made from the fund.

10. The method of claim 8, further comprising validating and settling payment transactions from partially validated funds.
